(19) United States
(12) Patent Application Publication
(10) Pub. No.: US 2013/0059042 A1
(43) Pub. Date: Mar. 7, 2013

(54) HANDLING APPARATUS FOR LIVESTOCK FEED SUPPLEMENT BLOCK

(71) Applicants: Ross Dean Dale, Pella, IA (US); Paul Gene Summer, Oskaloosa, IA (US); Dwayne Lyndon Jantz, Bloomfield, IA (US)

(72) Inventors: Ross Dean Dale, Pella, IA (US); Paul Gene Summer, Oskaloosa, IA (US); Dwayne Lyndon Jantz, Bloomfield, IA (US)

(73) Assignee: Golden Nutrition LLC, Oskaloosa, IA (US)

(21) Appl. No.: 13/403,739

(22) Filed: Feb. 23, 2012

Related U.S. Application Data
(60) Provisional application No. 61/445,789, filed on Feb. 23, 2011.

(51) Int. Cl. A23K 1/00

(52) U.S. Cl. 426/132; 426/420

(57) ABSTRACT

A handling apparatus for solidified livestock feed supplement blocks is disclosed. The handling apparatus includes a handle incorporated into the block at the time of manufacturing such that the handle is inherent or intrinsic to the block. A method of producing a handling apparatus for a solidified livestock feed supplement block is also disclosed, including incorporation of a handle into the block at the time of manufacturing such that the handle is inherent or intrinsic to the block.

### CROSS-REFERENCE TO RELATED APPLICATIONS

This application claims the benefit of U.S. Provisional Patent Application 61/445,789 entitled “HANDLING APPARATUS FOR LIVESTOCK FEED SUPPLEMENT BLOCK” filed on Feb. 23, 2011, the entire contents of which is hereby incorporated by reference herein in its entirety.

### FIELD

The invention relates primarily to the handling of solidified livestock feed supplement blocks and more particularly to the formation of an improved handling apparatus and a method for manufacturing a handle into solidified livestock feed supplement blocks.

### BACKGROUND

It is common practice to supplement livestock diets with purchased nutrients such as trace minerals, vitamins, protein and carbohydrates as required by the livestock. Supplements for livestock can be purchased in many forms such as loose mineral, pelleted feeds, salt blocks, mineral blocks, protein blocks and molasses blocks. Supplements formed into solidified blocks range in size from 30 pounds up to 250 pounds typically. Solidified livestock feed supplement blocks are advantageous because they permit free choice feeding to the animals, thereby reducing labor costs by not requiring daily supplement feeding. The animals lick a certain amount of feedstuff off of the supplement block daily and intake is limited by the hardness of the block.

Supplement blocks are commonly packaged in protective containers such as metal drums or plastic drums that have open tops, allowing access to the feedstuff. The containers are necessary and allow the supplement blocks to be placed onto the ground and outdoors. They keep the supplement block contained and prevent it from ‘falling apart’ as well as protect it from moisture due to rain or wet ground as well as keep the feedstuff clean of mud or dirt. Metal or plastic containers are very effective; however, they are cumbersome to handle due to their weight when full and lack of any handle that could be used to pick them up. Typically, the large blocks, weighing between 200 and 300 pounds, are picked up and moved mechanically by lifting from underneath with a set of forks such as on a forklift or tractor. Alternatively then can be moved manually by using a dolly cart or by rolling them on their side. Unloading the blocks from a pick-up truck presents more difficulty because it's difficult to place forks or a dolly underneath of them when in the bed of truck and rolling them off may cause damage to the block or potential injury to people and animals nearby. Therefore, there is a need for an improved handling method for solidified livestock feed supplement blocks. Further, there is a need for a user friendly and economical handling apparatus to facilitate easier and safer movement of livestock feed supplement blocks.

### SUMMARY

A handling apparatus for solidified livestock feed supplement blocks is provided. The handling apparatus includes a handle incorporated into the block at the time of manufacturing such that the handle is inherent or intrinsic to the block.

A method of producing a handling apparatus for a solidified livestock feed supplement block is also disclosed. The method includes incorporation of a handle into the block at the time of manufacturing of said block such that the handle is inherent or intrinsic to the block.

### BRIEF DESCRIPTION OF THE DRAWINGS

Various examples of embodiments of the apparatus, systems and methods according to the present disclosure will be described in detail, with reference to the following figures, wherein:

FIG. 1 is an elevation view of a handle or handling apparatus according to one or more examples of embodiments;

FIG. 2 is an isometric view of a handle or handling apparatus in a block according to one or more examples of embodiments, showing a portion of the block as transparent to illustrate one or more examples of the handle or handling apparatus in the block; and

FIG. 3 is an isometric view of a handle or handling apparatus in a block according to one or more examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

As indicated above, in various examples of embodiments, the present invention includes methods of producing a handling apparatus suitable for livestock feed supplement blocks that provides improved handling convenience. The present invention is also directed to a handling apparatus for livestock feed supplement blocks.

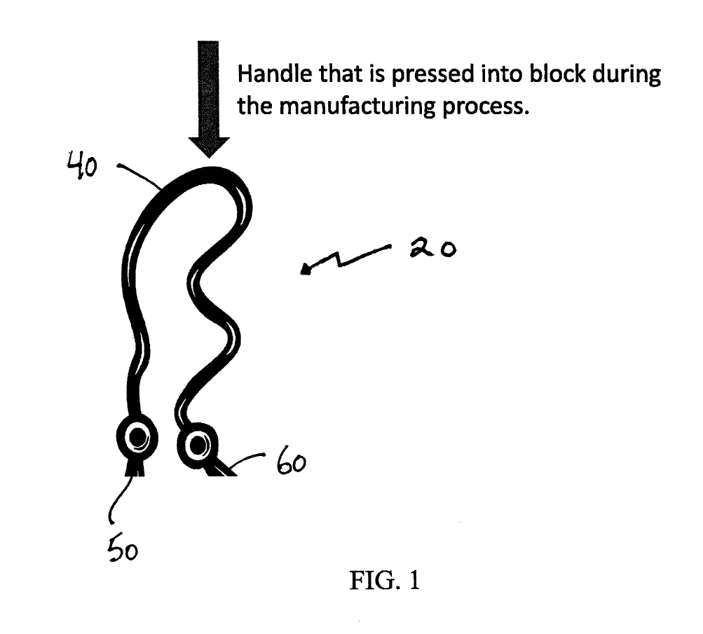

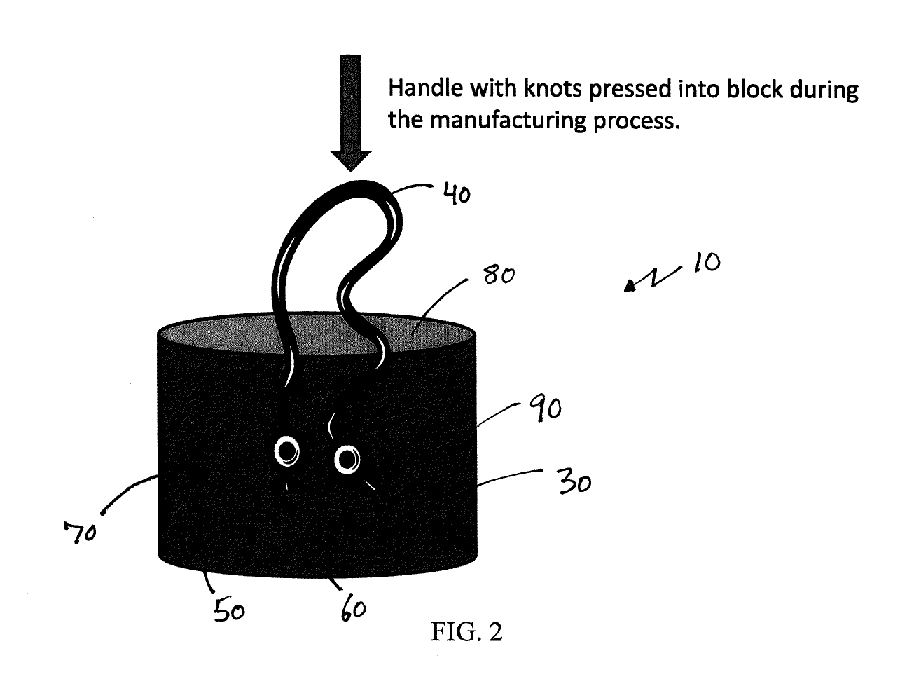

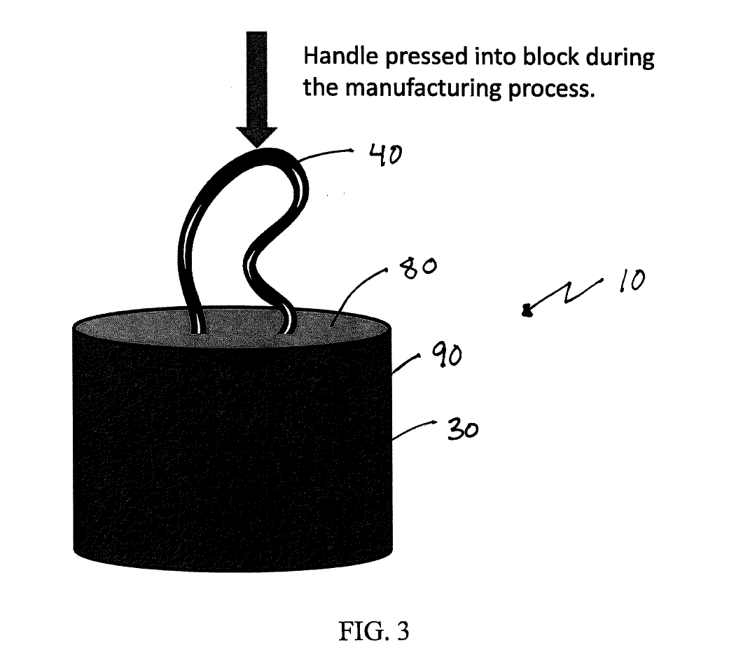

In various examples of embodiments, as shown in FIGS. 1-3, the handling apparatus 10 includes a handle 20 incorporated into the livestock feed supplement block 30. The handle 20 is incorporated into the block 30 during manufacturing of the supplement block 30. The handle 20 may be of made of materials including, but not limited to, rope, twine, plastic, metal, hemp, wood, or any combination of these materials. Preferably, the handle 20 is made of rope consisting of natural or synthetic fibers or a combination of natural and synthetic material. Natural fibers include, but are not limited to, hemp, sisal, cotton, flax and jute. Synthetic fibers include but are not limited to nylon, polyester, polypropylene, and aramid. Preferably, the handle 20 is composed of material that is biodegradable in the environment, but durable enough to remain intact during normal storage and handling of livestock feed supplement blocks 30. In one or more examples of embodiments, the handle 20 is composed of cotton.

The handling apparatus handle 20 is incorporated into the supplement block 30 at the time of manufacturing of the supplement block 30. In a preferred embodiment, a solidified livestock feed supplement block 30 is formed by any of a number of methods such as, but not limited to, those described by U.S. Pat. No. 4,027,043, U.S. Pat. No. 4,160,041, U.S. Pat. No. 4,171,385, U.S. Pat. No. 4,234,608, U.S. Pat. No. 4,431,675, U.S. Pat. No. 4,994,282, U.S. Pat. No. 5,068,114, U.S. Pat. No. 5,073,388, and U.S. Pat. No. 6,168,803 (The contents of each of these references is hereby incorporated herein by reference).

The solidified feed supplement may be manufactured by pouring combinations of liquid ingredients into a mold for reaction and solidification, or it may be comprised of primarily dry ingredients which are compressed under high pressure to form a solidified block 30. In any case, the solidified supplement block(s) 30 usually require a curing step and cooling step while chemical reactions reach their endpoints which results in the hard block 30. The handling apparatus handle 20 is incorporated into the block 30 prior to the curing step and is cemented into the block 30 as the supplement block 30 solidifies.

The handling apparatus 10 is adaptable to any block 30 size or multiple block sizes, providing a convenient method of handling a variety of blocks. In a preferred embodiment, the present invention forms a handling apparatus 10 for supplement block(s) 30 ranging in size from about 5 pounds to about 500 pounds, more preferably from about 30 pounds to about 300 pounds, and even more preferably from about 150 pounds to about 250 pounds.

The handling apparatus 10 may be employed for livestock feed supplement block(s) 30 packaged in any type of container, including but not limited to steel drums, plastic drums, plastic wrap, wax, or even no container. One suitable livestock feed supplement block 30 and container acceptable for use with the present invention is provided in U.S. patent application Ser. No. 13/293,297 for a Biodegradable, Edible, Weather Resistant Container for Livestock Feed Supplement Block, which is hereby incorporated by reference in its entirety herein.

The handling apparatus handle 20 is incorporated into the supplement block 30 by either manual or mechanical means. When the handling apparatus is composed of or includes a rigid material it is pushed into the supplement block 30 during manufacturing of the block 30. In a preferred embodiment, the handling apparatus handle 20 is composed of rope (formed of the materials described hereinabove) having a segment 40 for gripping or lifting or otherwise engagement with a device designed to move the block, and ends 50 and 60, which are inserted into the interior 70 of block 30 during manufacturing of the block 30 by using, for example, retractable prongs or rods (not shown). The retractable rods insert each end 50, 60 of the rope into the mass of feedstuff prior to the feed block 30 being compressed or solidified due to chemical reaction or by dehydration in poured blocks 30.

The handle ends 50, 60 are inserted into the block 30 to a depth equal to from about 10% to about 100% of the blocks' depth, more preferably from about 25% to about 80%, and even more preferably from about 35% to about 75% of the blocks' depth. In a preferred embodiment, the ends are inserted into the block 30 to equal 65% of the blocks' depth.

The handle ends 50, 60 are preferably located from about 20 degrees to about 180 degrees apart when viewed from the top, and more preferably from about 90 degrees to about 180 degrees. In a preferred embodiment the handle ends 50, 60 are 180 degrees separated. In yet another embodiment, it is possible for both ends to be inserted into the block 30 at the same location. In this case the ends 50, 60 may be inserted at any location on the top surface 80 and preferably in the center. Although alternative locations and surfaces of the block suitable for the intended purposes are also acceptable.

The handle ends 50, 60 may be inserted at any distance from each other in the block 30. In a preferred embodiment, the handle ends 50, 60 are placed equidistantly from the blocks' lateral surface(s) 90 at a distance equal to from about 10% to about 50% of the blocks' diameter, and more preferably from about 25% to about 45%, and even more preferably from about 30% to about 40%.

The handle ends 50, 60 are preferably knotted or enlarged in some way so as to increase the diameter of each end of the handle 20 which will serve to act as an anchor inside the block 30. The knotted or enlarged ends have a diameter that is from about 1.0 to about 3.0 times larger than the rest of the handle 20, and more preferably from about 1.2 to about 3.0 times larger, and even more preferably from about 1.5 to 2.5 times larger in diameter. In one or more examples of embodiment, 0.5 inch diameter cotton rope has a knot tied at each end to result in a diameter of 1.5 inches before being inserted into a feed supplement block 30.

While a single handle 20 is illustrated and described, more than one handle may be provided in the block 30 according to the method and arrangement described herein. Likewise, while the handle 20 is illustrated and described as including two ends 50, 60, one, two, or more than two ends may be provided according to the method and arrangement described herein.

The handling apparatus 10 is economically produced by using low cost materials such as rope, and is lower in cost as compared to, for example, attaching one or more handle(s) to a container package such as a steel drum.

Further, the present invention can be used for any solidified block 30 intended for use to supplement wildlife such as for example, deer, moose or caribou. Further, the present invention can be used for any solidified block 30 intended for use to supplement pets such as for example, dogs, cats, rabbits or horses.

The product of the present invention is an improved handling apparatus 10 for solidified livestock feed supplement block(s) 30. The present invention also provides a method for producing a handling apparatus 10 for solidified livestock feed supplement block(s) 30.

The handling apparatus 10 and method described herein include various advantages over existing devices. The handling apparatus improves handling convenience of livestock feed supplement blocks by incorporating a handle 20 directly into the block 30. The handling apparatus is economical to produce, can be incorporated into any size livestock feed supplement block, and can be incorporated into supplement blocks with any type of container and is therefore useful regardless of the block's package and size. The handling apparatus provides minimal waste when the supplement block is consumed and is preferably biodegradable.

These and other objects and advantages of the present invention are provided by a handling apparatus that is incorporated into a supplement block at the time of its' manufacturing as described herein.

Having generally described this invention, a further understanding can be obtained by reference to an example provided herein for purpose of illustration only and not intended to limit the scope of the invention unless otherwise specified.

### Example

A solidified livestock feed supplement block weighing 200 pounds was formed using the formula in Table 1. The ingredients were mixed thoroughly before placing them into an 18 inch diameter by 42 inch tall, tubular, steel mold sitting on a solid base. A cotton rope measuring 48 inches long and 0.5 inches in diameter was obtained. A knot was tied at each end to increase the diameter at each end to approximately 1.5 inches and to act as anchors when inserted into the block. Each end of the rope was then placed into slots measuring approximately 0.6 inches across and 0.5 inches deep that had been cut out of one inch steel rods. The rods were approximately 36 inches in length and were part of a mechanism designed to insert the rope ends into the supplement block while simultaneously compressing the supplement block into its' final solidified form and density. The rods extended perpendicularly through holes in the steel plate and were perpendicular to the top of the mold used to form the feed block. The holes for the rods were 180 degrees apart and each was 7 inches from the exterior of the compression plate. The steel plate was equal in size to the inside diameter of the tubular mold and was used for compressing the feed mixture into a solidified feed block. The rods and the steel plate were hydraulically operated. With the feedstuff mixture in the mold, the rods with each end of the rope handle and the steel compressing plate were hydraulically lowered into the tubular mold with the rods fully extended so that the rope ends would stop and be placed near the bottom of the mold. Meanwhile, the steel compressing plate continued to compress the feedstuff into a solidified feed block while the rods held the rope ends in place. Once adequate compression of the feedstuff was obtained, the rods were withdrawn, leaving the rope in the block. The supplement block was allowed to cool for at least 24 hours. The final result was a handling apparatus consisting of a cotton rope which was inbuilt into the livestock feed block with both ends incorporated in the block to leave a loop on the exterior of the block which served as a handle.

The supplement block with the present handling apparatus was placed into a field with 14 cows to observe the handling convenience of the block with the present invention handling apparatus as well as to observe any problems it may cause when used in supplement cows fed to cows. The block was easily moved by hooking the handle with the fork on a loader tractor and lifting it. It was observed that the cows readily consumed the block and were not bothered by the presence of the handling apparatus.

The cost of the cotton rope used to form the handling apparatus was approximately $0.80. There is no other known inbuilt feed supplement block handle known in the art to compare to economically; however, the added convenience the present invention provides readily offsets the cost.

TABLE 1
Solidified Livestock Feed Supplement Block

| Item | Weight % |
|---|---|
| Dried Distillers Grains | 50 |
| Cane Molasses | 25 |
| Whey | 11 |
| Phosphoric Acid | 2 |
| Processed Vegetable Oil | 2 |
| Calcium Oxide | 8 |
| Vitamin and Trace Mineral Mixture | 2 |

Presently preferred embodiments of the invention and many of its improvements have been described with a degree of particularity. The previous description is of preferred examples for implementing the invention, and the scope of the invention should not necessarily be limited by this description. Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, angled, and so forth) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly. As such, joinder references do not necessarily infer that two elements are directly connected and in fixed relation to each other. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented for purposes of the description. It should be recognized that the orientation of particular components may vary greatly depending on the application in which they are used.

It is also important to note that the construction and arrangement of the feedstock and/or container and/or handle or handling apparatus as described in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements described as integrally formed may be constructed of multiple parts or elements show as multiple parts may be integrally formed, the interfaces may be reversed or otherwise varied, the length or width of the structures and/or members or other elements of the device or composition may be varied, the nature or number of adjustment positions provided between the elements may be varied. The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

What is claimed is:

1. A handling apparatus for solidified livestock feed supplement blocks comprising a handle incorporated into the block at the time of manufacturing such that the handle is inherent or intrinsic to the block.

2. The apparatus of claim 1, wherein the handle is comprised of rope, twine, plastic, metal, wood or any combination of the foregoing.

3. The apparatus of claim 1, wherein the handle is comprised of rope made from natural, synthetic or a combination of natural and synthetic fibers.

4. The apparatus of claim 1, wherein the handle is comprised of natural fibers of hemp, sisal, cotton, flax, jute, or any combination of the foregoing.

5. The apparatus of claim 1, wherein the handle is biodegradable.

6. The apparatus of claim 1, wherein the handle is inbuilt into feed supplement blocks from about 5 pounds to about 500 pounds, more preferably from about 30 pounds to about 300 pounds, and even more preferably from about 150 pounds to about 250 pounds.

7. The apparatus of claim 1, wherein the handle is incorporated into the manufacture of feed supplement blocks by either manual or mechanical means.

8. The apparatus of claim 1, wherein the handle ends are inbuilt into feed supplement blocks to a depth equal to from about 10% to 100%, more preferably from about 25% to about 80%, and even more preferably from about 35% to about 75%.

9. The apparatus of claim 1, wherein the handle ends are located from about 20 degrees to 180 degrees apart on the top surface of the supplement block.

10. The apparatus of claim 1, wherein the handle has just one end.

11. The apparatus of claim 1, wherein the handles are located equidistantly from the blocks' lateral surface at a distance equal to form about 10% to about 50% of the blocks diameter, more preferably from about 25% to about 45%, and even more preferably from about 30% to about 40%.

12. The apparatus of claim 1, wherein the handle ends are enlarged compared with its' shaft by from about 1.0 to 3.0 times, more preferably from about 1.2 to about 3.0 times, and even more preferably from about 1.5 to about 1.5 to abut 2.5 times larger in diameter to act as an anchor when inbuilt into the feed supplement block.

13. The apparatus of claim 1, wherein the handling apparatus is used to improve the handling convenience of livestock feed supplement blocks used to supplement livestock including but not limited to cattle, swine or horses.

14. The apparatus of claim 1, wherein the handling apparatus is used to improve the handling convenience of livestock feed supplement blocks used to supplement any domesticated pet including but not limited to dogs, cats or horses.

15. The apparatus of claim 1, wherein the handling apparatus is used to improve the handling convenience of livestock feed supplement blocks used to supplement any wildlife animals including but not limited to deer, caribou or moose.

16. A method of producing a handling apparatus for a solidified livestock feed supplement block comprising incorporation of a handle into the block at the time of manufacturing such that the handle is inherent or intrinsic to the block.

17. The method of claim 16, wherein the handle is comprised of rope, twine, plastic, metal, wood or any combinations of the foregoing.

18. The method of claim 16, wherein the handle is comprised of rope made from natural, synthetic or a combination of natural and synthetic fibers.

19. The method of claim 16, wherein the handle is comprised of natural fibers of hemp, sisal, cotton, flax, jute, or any combination of the foregoing.

20. The method of claim 16, wherein the handle is biodegradable.

21. The method of claim 16, wherein the handle is inbuilt into feed supplement blocks from about 5 pounds to about 500 pounds, more preferably from about 30 pounds to about 300 pounds, and even more preferably from about 150 pounds to about 250 pounds.

22. The method of claim 16, wherein the handle is incorporated into the manufacture of feed supplement blocks by either manual or mechanical means.

23. The method of claim 16, wherein the handle ends are inbuilt into feed supplement blocks to a depth equal to from about 10% to 100%, more preferably from about 25% to about 80%, and even more preferably from about 35% to about 75%.

24. The method claim 16, wherein the handle ends are located from about 20 degrees to 180 degrees apart on the top surface of the supplement block.

25. The method of claim 16, wherein the handle has just one end.

26. The method of claim 16, wherein the handles are located equidistantly from the blocks' lateral surface at a distance equal to form about 10% to about 50% of the blocks diameter, more preferably from about 25% to about 45%, and even more preferably from about 30% to about 40%.

27. The method of claim 16, wherein the handle ends are enlarged compared with its' shaft by from about 1.0 to 3.0 times, more preferably from about 1.2 to about 3.0 times, and even more preferably from about 1.5 to about 1.5 to abut 2.5 times larger in diameter to act as an anchor when inbuilt into the feed supplement block.

28. The method of claim 16, wherein the handling apparatus is used to improve the handling convenience of livestock feed supplement blocks used to supplement livestock including but not limited to cattle, swine or horses.

29. The method of claim 16, wherein the handling apparatus is used to improve the handling convenience of livestock feed supplement blocks used to supplement any domesticated pet including but not limited to dogs, cats or horses.

30. The method of claim 16, wherein the handling apparatus is used to improve the handling convenience of livestock feed supplement blocks used to supplement any wildlife animals including but not limited to deer, caribou or moose.
